(19) United States
(12) Patent Application Publication
(10) Pub. No.: US 2009/0179445 A1
(43) Pub. Date: Jul. 16, 2009

(54) ROTATING GRIPPER ASSEMBLY UTILIZING STEPPER MOTORS

(76) Inventor: William E. Coville, Levittown, PA (US)

Correspondence Address: William E Coville, 125 Highland Park Drive, Levittown, PA, 19056, US

(21) Appl. No.: 12/014,226

(22) Filed: Jan. 15, 2008

(51) Int. Cl. B66C 1/42

(52) U.S. Cl. 294/106

(57) ABSTRACT

A gripper assembly including a rotary motor and a linear motor disposed within the rotor housing is provided. The linear motor includes a longitudinally slideable push rod and a pair of oppositely moving fingers. Each of the fingers is pivotally attached adjacent an end of the longitudinally slideable push rod. The push rod is moveable upon actuation of the linear motor to cause the fingers to move symmetrically toward and away from each other. Upon actuation of the rotary motor, rotational movement of the longitudinally slideable push rod causes the fingers to synchronously rotate. These actions are monitored by the microprocessor through additional circuitry to monitor the electrical current, amperage, consumed for each pulse which indicated the mechanical resistance to the movement.

### BACKGROUND

Conventional grippers are typically comprised of intricate, highly machined parts that render the assembly expensive and difficult to manufacture.

Current commercial designs come from the heavy machinery markets and have been scaled down to be used on small parts. As these designs were scaled down they retained the machine design features and are not designed for instrument applications.

Known commercial grippers require high pneumatic pressures or servo motor drives to operate the gripping action. These actions are full open and full closed positions, or require position sensors integrated into the servomotors which increases the complexity of the gripper assembly.

High pneumatic pressures can pose serious safety risks. Furthermore, pneumatic systems add to the complexity and cost of an assembly and require periodic maintenance (e.g., to replace seals, valves, compressors, regulators, filters etc).

The general size of most gripper assemblies makes them undesirable for smaller applications. Moreover, custom designing, revisions or implementing modifications to a standard gripper are cost prohibitive.

Accordingly, there remains a need for an improved gripper assembly that is relatively simple, inexpensively constructed, versatile, and suitable for smaller applications.

### SUMMARY

The present invention provides a gripper assembly including a rotary motor and a linear motor disposed within the rotary motor. The linear motor includes a longitudinally slidable driven push rod and a pair of oppositely moving fingers. Each of the fingers is pivotally attached adjacent an end of the longitudinally slidable push rod. The push rod is moveable upon actuation of the linear motor to cause the fingers to move symmetrically toward and away from each other. This motion may be pivoting action about the pins or along linear guides via linkages. Upon actuation of the rotary stepper motor, rotational movement of the gripper fingers either on or about the center axis of the rotary motor.

The present invention further provides a gripper assembly having a motor end, a gripper end, and a longitudinal axis, the gripper assembly including a gripper body, a linear motor at least partially disposed within the gripper body, and a longitudinally slidable motor push rod substantially disposed within the gripper body.

The linear drive is mounted within the rotary motor, with its' body part mounted within the rotor of the rotating drive and utilizing the bearings of the rotary drive as design elements.

The push rod has a motor end in communication with the linear motor and a gripper end. The gripper assembly further includes a pair of oppositely moving fingers, each of the fingers having a pivot end and a mid-section, the pivot end of each finger being pivotally attached to the flange of the gripper body. The gripper assembly also has a pair of oppositely moving linkages, each of the linkages having one end pivotally attached to the longitudinally screw driven push rod adjacent the gripper end and another end pivotally attached to the mid-section of the respective finger.

The gripper element has several methods of translating the linear action of the linear motor to a gripping action.

This linkage design may attach between the pivot pin and the fingers (3rd class lever assembly) or be attached behind the pivot pin to provide different mechanical advantages (2nd class lever assembly). The arm may also be a bell-crank design to vary the clamping characteristics.

A parallel gripping head design where the grippers travel along guides is an option for gripping and processing larger sized items.

The push rod is moveable upon actuation of the linear motor in a first direction toward the motor end of the assembly so that the fingers move symmetrically toward each other and in a second direction toward the gripper end of the assembly so that the fingers move symmetrically away from each other. This allows for internal and external gripping action.

The present invention also provides a gripper assembly having a motor end, a gripper end, and a longitudinal axis, the gripper assembly including an annular gripper body having, a linear slidable motor at least partially disposed within the gripper body, and a rotary motor encasing the linear motor. A longitudinally slidable push rod is substantially disposed within the gripper body, the push rod including a motor end in communication with the linear motor and a gripper end. The gripper assembly further includes a pair of oppositely moving fingers, each of the fingers including a pivot end and a mid-section, the pivot end of each finger being pivotally attached to the flange of the gripper body. The gripper assembly also has a pair of oppositely moving linkages, each of the linkages having one end pivotally attached to the longitudinally slidable push rod adjacent the gripper end and another end pivotally attached to the mid-section of the respective finger. Upon actuation of the linear motor, linear movement of the longitudinally slidable push rod in a direction toward the motor end of the assembly causes the fingers to move symmetrically toward each other, and linear movement of the longitudinally slidable push rod in a direction toward the gripper end of the assembly causes the fingers to move symmetrically away from each other. Upon actuation of the rotary motor, rotational movement of the gripper body causes the fingers to synchronously rotate.

In yet another embodiment of the present invention, a gripper assembly may be provided as described above in the previous paragraph with a rotary motor encasing a linear motor.

### BRIEF DESCRIPTION OF THE DRAWINGS

The foregoing summary, as well as the following detailed description, will be readily understood in conjunction with the appended drawings which illustrate the preferred embodiments of the invention in the drawings.

FIG. 1 is a schematic plan view of a gripper assembly including a rotary motor encasing a linear stepper motor in accordance with the present invention;

FIG. 2 is a schematic plan view of a gripper assembly including a rotary stepper motor encasing a linear motor in accordance with the present invention;

FIG. 3 is a exploded plan view of a gripper assembly including the major components; FIG. 3A Gripper Head Assembly, FIG. 3B Rotary Motor Assembly, FIG. 3c Linear motor Assembly in accordance with the present invention:

FIG. 4A is a partial side schematic view of the gripper assemblies of FIGS. 1 and 2 showing a pair of substantially straight fingers gripping an object;

FIG. 4B is a partial side schematic view of the gripper assemblies of FIGS. 1 and 2 showing a pair of segmented fingers in a substantially right-angled configuration gripping an object; and

FIG. 5 is a partial side schematic view of the gripper assemblies adapted for a linear guide parallel action gripping utilizing a basic sliding block linkage driven with a linear motor in accordance with the present invention;

### DETAILED DESCRIPTION OF THE PREFERRED EMBODIMENTS

Certain terminology is used in the following description for convenience only and is not considered limiting. Words such as “front,” “back,” “top,” and “bottom” designate directions in the drawings to which reference is made. This terminology includes the words specifically noted above, derivatives thereof, and words of similar import. Additionally, the terms “a” and “one” are defined as including one or more of the referenced item unless specifically noted. The phrase “at least one of” followed by a list of two or more items, such as A, B, or C, means any individual one of A, B, or C, as well as any combination thereof.

The preferred embodiments of the present invention are described below with reference to the drawing figures where like numerals represent like elements throughout.

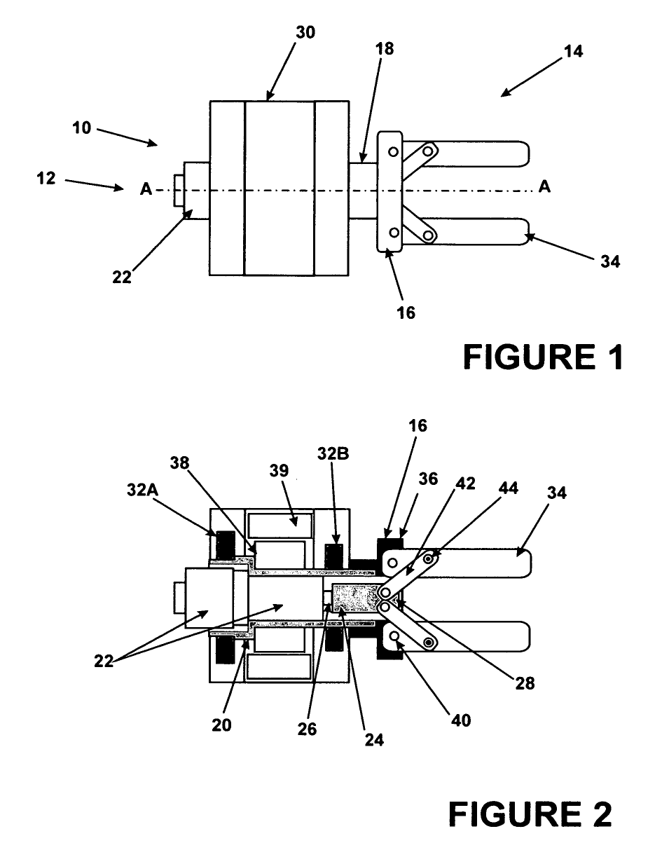

Referring to FIGS. 1 and 2, schematic plan views are shown of a gripper assembly 10 including a motor end 12, a gripper end 14, and a longitudinal axis A. The gripper assembly 10 further includes an gripper head 16 having a connecting flange 18, and a rotor housing 20 at least encasing the rotary motor 30. A linear motor 22 is at least partially disposed within a rotor housing 20 and the rotary motor 30, and a longitudinally screw driven push rod 24 is substantially disposed within a rotor housing 20 and the rotary motor 30. The push rod 24 has a motor end 26 in communication with the linear motor 22 and a gripper end 28 communication with the moving linkages 42. The rotary motor is a modification to make the shaft of the rotor a housing 20 for the linear stepper motor 22. The rotor housing 20 is mounted in the permanent magnet 38, which is turned by the stator 39. The rotor housing 20 is supported on the bearings 32A, 32B.

The gripper assembly 10 further includes a pair of oppositely moving fingers 34, each of the fingers 34 having a pivot end 36. The pivot end 36 of each finger 34 is pivotally attached to the gripper head 16 with, for example, respective pivot pins 40. The gripper assembly 10 also has a pair of oppositely moving linkages 42, each of the linkages 42 has one end that is pivotally attached to the longitudinally screw driven push rod 24 adjacent its gripper end 28 and another end pivotally attached to the mid-section of the respective finger 34 with, for example, respective pivot pins 44. The securing devices of the pivotal attachments of the present invention, however, are not limited to pivot pins 40, 44, and may include any type of rotational or hinge-like device suitable to adequately achieve the desired pivotal functions having kinematic design features such as paring links designed to increase motion or increase strength or reverse the direction of the drive element.

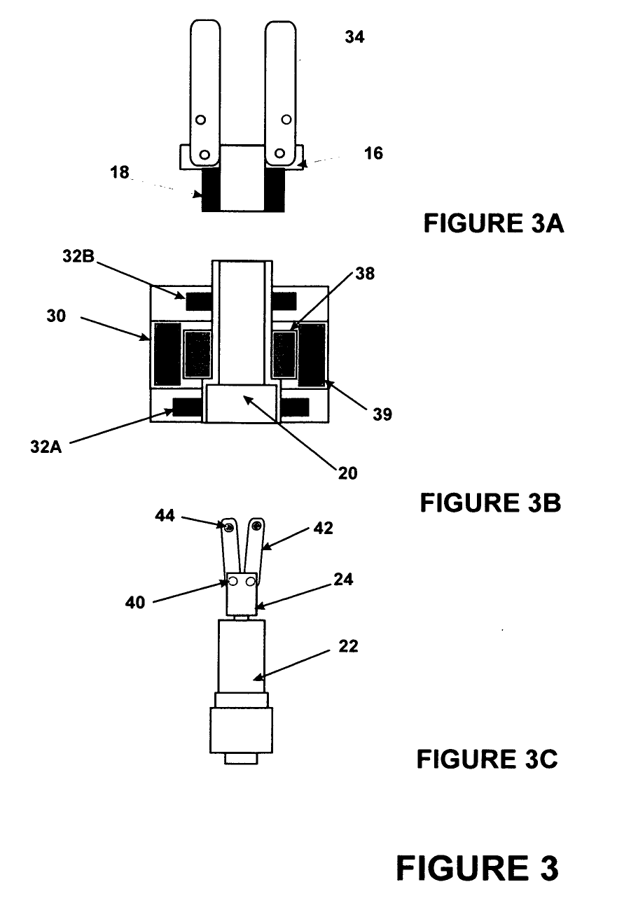

As represented in FIG. 3, the rotary griper is comprised of three subassemblies as shown in 3A, 3B, and 3C. FIG. 3A shows the gripper head 16 and flange 18 with the fingers 34. This assembly connects to the rotor housing 20 that is illustrated in FIG. 3B. FIG. 3B also details the rotary motor 30 configuration which includes the rotor housing 20 and the rotor 38, mounted on the bearings 32A and 32B with the stator 39 positioned in the rotary motor housing 30. FIG. 3C illustrates the linear motor 22 attached to the longitudinally screw driven push rod 24, that in turn is attached to the gripper end 28 communication with the moving linkages 42.

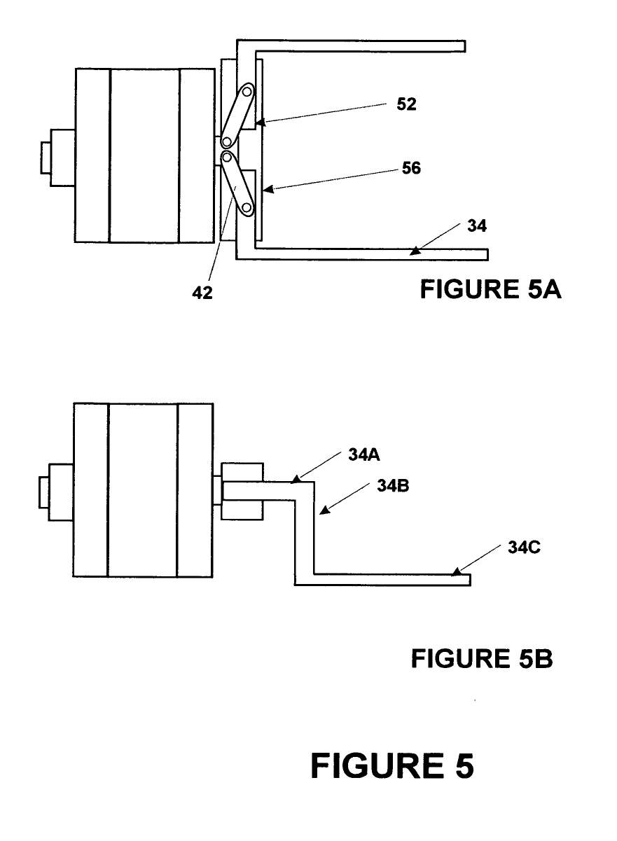

As represented in FIG. 5, the kinematic design utilizes a sliding block design to provide parallel gripping action. The block 52 may be mounted in a machined guide or on a rod 56 to translate the angular outward force to parallel sideward forces.

As represented in FIG. 1, the linear motor may be a linear stepper motor 22. As represented in FIG. 2, the rotary motor may be a rotary stepper motor 30. The stepping increments of a stepper motor allow for more precise control of the gripper assembly 10 as compared to known grippers.

In use, the push rod 24 is moveable upon actuation of the motors 22, 30. More specifically, upon actuation of the linear motor 22 linear movement of the longitudinally screw driven push rod 24 in a direction toward the motor end 12 of the assembly 10 causes the fingers 34 (through their respective pivotal connections to the gripper head connecting flange 18 and to the push rod 24 through the linkages 42) to move symmetrically toward each other. Such movement enables the fingers 34 to grip an object. Conversely, linear movement of the longitudinally screw driven push rod 24 in a direction toward the gripper end 14 of the assembly 10 causes the fingers 34 (through their respective pivotal connections to the gripper head connecting flange 18 and to the push rod 24 through the linkages 42) to move symmetrically away from each other. Such movement causes the fingers 34 to release the object (not shown).

Generally, the clamping force of the fingers 34 of the gripping assembly 10 may range from about 18 ounces per square inch to 150 pounds per square inch, but the gripping assembly 10 of the present invention may be configured to achieve clamping forces outside this range if necessary. The gripping force ranges may be varied by varying the length of the fingers 34 and the locations of their respective pivot points and the size of the linear motor.

Actuation of the rotary motor 30 causes rotational movement of the housing 20, mounted in bearings 32A, 32B and the gripper head 16 which, in turn causes the fingers 34 to synchronously rotate. Thus, once an object is gripped by the fingers 34, it can be rotated as desired, for example, to invert a component or mix a specimen in a container. The rotational accuracy of the gripper assembly 10 of the present invention is about 0.5 degrees.

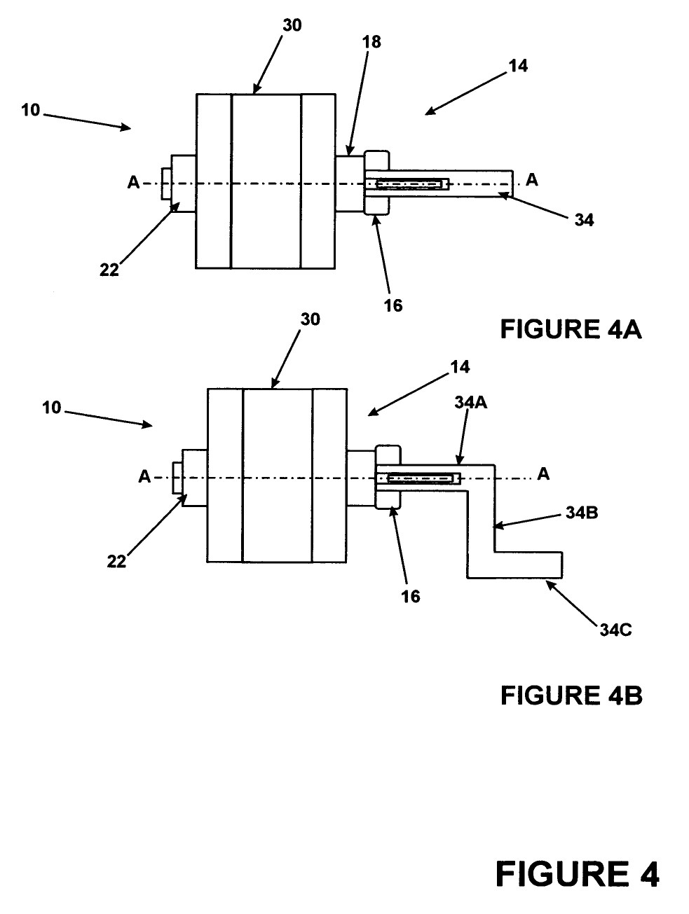

The configuration of the fingers 34 may vary depending upon the application, as illustrated by the partial side schematic views of the gripper assembly 10 represented in FIGS. 4A, 4B and FIG. 5A, 5B. More specifically, for example, each of the fingers 34 may be substantially straight and extend parallel with the longitudinal axis A as represented in FIG. 4A. In an alternative configuration, and as represented in FIG. 4B, each of the fingers 34 may include two substantially straight segments 34A extending parallel with the longitudinal axis A, and one substantially straight segment 34B extending perpendicular with the longitudinal axis A and connecting the longitudinally parallel segments 34C. The finger assembly of the present invention, however, is not limited to these arrangements, and the size, shape, and configuration of the fingers 34 may be designed for a particular task as desired. Similarly, the fingers 34 are readily accessible and may be easily replaced or changed to a different configuration on a particular gripper assembly 10 while installed in a system to set up a new application, as desired, thereby enhancing the versatility of the gripper assembly 10 of the present invention.

The linear and rotary motors are controlled by a microprocessor and drive circuitry located on a remote printed circuit board (not shown). Each motor has a distinct drive circuitry that is instructed by the microprocessor software to incrementally pulse the stepper motor coils to rotate the rotor magnets and index the rotary or linear position of the motors to a defined location to perform an operation of gripping or rotating an object. These actions are monitored by the microprocessor through additional circuitry to monitor the electrical current, amperage, consumed for each pulse which indicated the mechanical resistance to the movement. This resistance indicated when the gripper has contacted the object or when the rotary motion has contacted a physical stop, i.e. fingers open or closed, rotation at either end of its rotation. This sensing circuit replaces the more complex encoder electrical mechanical assemblies used for positional sensing.

The object, can be any object of any shape The application defines the shape and size of the fingers 34, and may utilized to grip a variety of objects in a variety of settings, for example, in the clinical laboratory automation industry, the computer board component placement industry, and various other automated industries.

The size of the gripper assembly 10 of the present invention is relatively small as compared to known grippers. At a gripping force of 18 ounces per square inch, the size of the assembly 10 (without fingers 34) is about 2.38 inches long by 1.66 inches square. At a gripping force of 150 pounds per square inch, the size of the assembly 10 (without fingers 34) is about 4.0 inches long by 3.39 inches square.

While the preferred embodiments of the invention have been described in detail above, the invention is not limited to the specific embodiments described which should be considered as merely exemplary. Further modifications and extensions of the present invention may be developed and all such modifications are deemed to be within the scope of the present invention as defined by the appended claims.

What is claimed is:

1. A gripper assembly comprising:
a) a rotary motor;
b) a linear motor disposed within the rotor housing, the linear motor comprising a longitudinally slideable push rod; and
c) a pair of oppositely moving fingers, each of the fingers pivotally attached adjacent an end of the longitudinally slideable push rod;
ii) the push rod being moveable upon actuation of the linear motor to cause the fingers to move symmetrically toward and away from each other, and
iii) upon actuation of the rotary motor, rotational movement of the longitudinally slideable push rod causes the fingers to synchronously rotate.

2. A gripper assembly having a motor end, a gripper end, and a longitudinal axis, the gripper assembly comprising:
a) a linear motor at least partially disposed within the rotor housing;
b) a longitudinally slideable push rod substantially disposed within the gripper body, the push rod including a motor end in communication with the linear motor and a gripper end;
c) a pair of oppositely moving fingers, each of the fingers having a pivot end and a mid-section, the pivot end of each finger being pivotally attached to the flange of the gripper head; and
d) a pair of oppositely moving linkages, each of the linkages having one end pivotally attached to the longitudinally slideable push rod adjacent the gripper end and another end pivotally attached to the mid-section of the respective finger;
ii) the push rod being moveable upon actuation of the linear motor in a first direction toward the motor end of the assembly so that the fingers move symmetrically toward each other, and in a second direction toward the gripper end of the assembly so that the fingers move symmetrically away from each other.

3. The gripper assembly of claim 2, wherein the linear motor comprises a linear stepper motor.

4. The gripper assembly of claim 2, further comprising a rotary motor encasing the linear motor, wherein upon actuation of the rotary motor, rotational movement of the gripper body causes the fingers to synchronously rotate.

5. The gripper assembly of claim 4, wherein the rotary motor comprises a rotary stepper motor.

6. The gripper assembly of claim 2, wherein each of the fingers is substantially straight and extends parallel with the longitudinal axis.

7. The gripper assembly of claim 2, wherein each of the fingers comprises two substantially straight segments extending parallel with the longitudinal axis, and one substantially straight segment extending perpendicular with the longitudinal axis and connecting the longitudinally parallel segments to each other.

8. The gripper assembly of claim 2, wherein each of the fingers comprises two substantially straight segments extending parallel with the longitudinal axis, and one substantially straight segment extending angularly in relation to the longitudinal axis and connecting the longitudinally parallel segments to each other.

9. The gripper assembly of claim 2, further comprising a control circuit in communication with the linear motor to control the movement of the fingers with respect to each other.

10. The gripper assembly of claim 13, further comprising at least one sensor in the electronics to monitoring a gripping force between the fingers and providing feedback to the control circuit software.

11. The gripper assembly of claim 13, further comprising at least one sensor in the electronics to monitor the extreme positions of the rotational position and providing feedback to the control circuit software.

12. The gripper assembly of claim 13, further comprising at least one sensor in the electronics to monitor the extreme positions of the gripping position and providing feedback to the control circuit software.

13. A gripper assembly having a motor end, a gripper end, and a longitudinal axis, the gripper assembly comprising:
a) a linear stepper motor at least partially disposed within the rotor housing;
b) a rotary motor encasing the linear motor;
c) a longitudinally slideable push rod substantially disposed within the rotor housing, the push rod comprising a motor end in communication with the linear stepper motor and a gripper end;
d) a pair of oppositely moving fingers, each of the fingers including a pivot end and a mid-section, the pivot end of each finger being pivotally attached to the flange of the gripper body; and
e) a pair of oppositely moving linkages, each of the linkages having one end pivotally attached to the longitudinally slideable push rod adjacent the gripper end and another end pivotally attached to the mid-section of the respective finger;
ii) wherein upon actuation of the linear stepper motor, linear movement of the longitudinally slideable push rod in a direction toward the motor end of the assembly causes the fingers to move symmetrically toward each other, and linear movement of the longitudinally slideable push rod in a direction toward the gripper end of the assembly causes the fingers to move symmetrically away from each other, and
iii) upon actuation of the rotary motor, rotational movement of the gripper body causes the fingers to synchronously rotate.

14. A gripper assembly having a motor end, a gripper end, and a longitudinal axis, the gripper assembly comprising:
a) a linear motor at least partially disposed within the rotor housing;
b) a rotary stepper motor encasing the linear motor;
c) a longitudinally slideable push rod substantially disposed within the gripper body, the push rod comprising a motor end in communication with the linear motor and a gripper end;
d) a pair of oppositely moving fingers, each of the fingers comprising a pivot end and a mid-section, the pivot end of each finger being pivotally attached to the flange of the gripper head; and
e) a pair of oppositely moving linkages, each of the linkages having one end pivotally attached to the longitudinally slideable push rod adjacent the gripper end and another end pivotally attached to the mid-section of a respective finger;
ii) wherein upon actuation of the linear motor, linear movement of the longitudinally slideable push rod in a direction toward the motor end of the assembly causes the fingers to move symmetrically toward each other, and linear movement of the longitudinally slideable push rod in a direction toward the gripper end of the assembly causes the fingers to move symmetrically away from each other, and
iii) upon actuation of the rotary stepper motor, rotational movement of the gripper head causes the fingers to synchronously rotate.
